(19) United States
(12) Patent Application Publication
(10) Pub. No.: US 2025/0219123 A1
(43) Pub. Date: Jul. 3, 2025

(54) SYSTEM AND METHOD FOR BATTERY STACKING AND SINGULATING A FILM MATERIAL

(71) Applicant: DW Energy LLC, Wilsonville, OR (US)

(72) Inventors: Derek Graham AQUI, Portland, OR (US); Christopher BARNS, Portland, OR (US); Alan SWAN, King City, OR (US); Brady BYERS, Newberg, OR (US); Alex MONTES, Portland, OR (US); Gautam DHAR, Tualatin, OR (US); Greyson MOFFAT, Portland, OR (US)

(21) Appl. No.: 19/001,729

(22) Filed: Dec. 26, 2024

Related U.S. Application Data
(60) Provisional application No. 63/615,017, filed on Dec. 27, 2023.
(60) Provisional application No. 63/615,013, filed on Dec. 27, 2023.
(60) Provisional application No. 63/615,009, filed on Dec. 27, 2023.

(51) Int. Cl. H01M 10/04

(52) U.S. Cl. CPC H01M 10/0404; H01M 10/049

(57) ABSTRACT

The present disclosure relates to a system for transferring and stacking electrodes in a battery stacking system. The system includes singulation device having a buffering device that feeds singulated electrodes to in-feed conveyors that transport the singulated electrodes to a transporting device having vacuum-assisted gripping shoes. The transporting device transfers the electrodes from the in-feed conveyors to the picking device equipped with gripping shoes to pick and place the battery materials into a stack on a stacking platform.

### CROSS-REFERENCE TO RELATED APPLICATIONS

This application claims the benefit of and priority to U.S. Application Ser. No. 63/615,017, filed Dec. 27, 2023; U.S. Application Ser. No. 63/615,013, filed Dec. 27, 2023; and U.S. Application Ser. No. 63/615,009, filed Dec. 27, 2023, the contents of each of which are hereby fully incorporated herein by reference.

### COPYRIGHT NOTIFICATION

Portions of this patent application contain materials that are subject to copyright protection. The copyright owner has no objection to the facsimile reproduction by anyone of the patent document or the patent disclosure, as it appears in the U.S. Patent and Trademark Office, but otherwise reserves all copyright rights whatsoever.

### FIELD OF THE DISCLOSURE

The present disclosure relates generally to methods, systems, and devices for battery stacking. Including systems and methods for singulating film material, in other words, cutting a film material from a web or a roll into discrete pieces, wherein the film material is a separator material used in battery manufacturing.

### BACKGROUND OF THE DISCLOSURE

Prismatic batteries are formed by interleaving alternate layers of cathodes, a film material in the form of an insulating separator, and anodes. There should be no electrical contact between an anode and an adjacent cathode to avoid malfunction. Accordingly, to form a battery stack, the separator material is a layer between the alternating anode and cathode layers.

There are different ways of achieving a battery stack with anodes, cathodes, and separators in between. One of the ways to fold the separator back and forth between the alternating anode and cathode layers is called a z-fold.

When manufacturing battery stacks, many different devices and method steps are involved. It would be beneficial to increase the speed of the manufacturing process, but to do that, improvement is needed in multiple areas of both the systems and methods used.

Another way is to cut the separator material into discrete sheets and laminate them, and place one sheet between each layer of anode and cathode. The separator is generally made from a very thin and flexible material, which makes it very difficult to handle without deforming or otherwise negatively impacting it, without performing lamination or subjecting it to another similar treatment. However, the lamination process adds an additional step, making the entire production process more complicated.

Battery stacking, a critical process in modern battery manufacturing, involves arranging multiple battery cells to form a complete module or pack. The cells, which can be cylindrical, prismatic, or pouch-shaped, are stacked in layers with alternating anode and cathode layers, separated by insulating separators. This stacking process aims to increase the energy density and power capacity of battery systems, making it a key technology in applications such as electric vehicles (EVs), grid storage, and portable electronics. The stacking process must ensure consistent alignment and minimal spacing to avoid performance losses or safety risks due to short circuits or thermal events.

In the stacking process, automated systems are often used to handle the precise placement of electrodes and separators. The critical challenge in battery stacking manufacturing is maintaining high throughput while ensuring the accurate alignment of each layer. This is particularly important in high-performance batteries, such as those using lithium-ion chemistry, where even slight misalignments can affect the electrochemical performance and lifecycle of the battery. Innovations in automation and robotics, such as laser alignment and machine vision systems, are increasingly employed to improve the precision and speed of the stacking process. This not only enhances production efficiency but also significantly reduces the cost of high-volume battery manufacturing, painting an optimistic picture of the future of the industry.

Another essential consideration in battery stacking manufacturing is the need for effective quality control. As batteries become more energy-dense and are used in safety-critical applications, such as EVs, the quality and consistency of the stacking process must be monitored in real-time. Techniques like X-ray inspection and impedance spectroscopy detect defects, such as misaligned cells or foreign particles, that may lead to performance degradation or safety issues. As the demand for higher-capacity batteries continues to grow, further advancements in automation, materials handling, and defect detection technologies will be crucial for scaling up battery stacking manufacturing while maintaining stringent safety and performance standards.

Z-folding batteries, while offering higher energy density by vertically stacking cells in layers, come with several limitations and challenges. One of the primary issues is the difficulty in ensuring precise alignment across multiple layers, as any misalignment can result in uneven pressure distribution, leading to mechanical stress on the electrodes and separators. This can cause performance degradation, internal short circuits, or even thermal runaway in extreme cases. Because Z-folding requires continuously offsetting the separator web from side-to-side during lamination to fold over to the next layer, visually inspecting the stack for accuracy and minimizing excess electrode and separator material to prevent the mechanical issues described above are difficult and expensive to implement. Leading to higher manufacturing costs due to large amounts of wasted material per stack manufactured.

Another challenge is heat dissipation; with cells stacked closely together, heat can accumulate within the pack, increasing the risk of overheating and reducing the battery's overall lifespan. Additionally, the complexity of automated stacking processes, particularly for thin and flexible components like separators in lithium-ion batteries, can lead to manufacturing defects if not carefully controlled. These limitations highlight the need for advanced manufacturing techniques and rigorous quality control measures to ensure the safety and reliability of z-stacked batteries in high-demand applications like electric vehicles and energy storage systems.

It would be beneficial if better handling of separator material in battery production could be achieved. Consequently, there exists a need for improvement when it comes to battery manufacturing in general and when it comes to handling of separator material in particular.

Therefore, what is missing in battery stacking systems today is a battery stacking system and method that contains more advanced alignment technologies and real-time quality control methods that can ensure greater precision and reduce manufacturing defects at scale than traditional Z-folding systems. It would be beneficial to be able to increase the speed of the manufacturing process, but in order to do that, improvement is needed in multiple different areas of both the systems and methods used.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended to determine the scope of the claimed subject matter.

The present disclosure aims to provide improved systems and methods for battery stacking, especially for manufacturing prismatic batteries comprising layers of anodes, cathodes, and separator material. One aim is to provide systems and methods which are faster than what is currently available.

It is an object of the invention to address at least some of the problems and issues outlined above. An object of embodiments of the invention is to provide a device for singulating film material, particularly for singulating separator material used in battery manufacturing.

An object of embodiments of the invention is to provide a buffering device for receiving film material at a constant speed and outputting it at a varying speed. In some embodiments, the outputting is done in a motion comprising rapid acceleration followed by rapid deceleration and a complete stop. Another objective is to enable high-speed manufacturing, such as battery manufacturing.

A first aspect of the present disclosure generally relates to a system for stacking singulated electrodes in a battery stack. The system comprises a first singulation device having at least three faces, a cutting device, and a first buffering device, wherein the first singulation device is configured to singulate electrodes from a film material; a second singulation device having at least three faces, a cutting device, and a second buffering device, wherein the first singulation device is configured to singulate electrodes from a film material; a third singulation device having at least three faces, a cutting device, and a third buffering device, wherein the first singulation device is configured to singulate electrodes from a film material; a first in-feed conveyor, wherein the first in-feed conveyor is configured to transport the singulated electrodes from the first singulation device to a first nest; a second in-feed conveyor, wherein the second in-feed conveyor is configured to transport singulated electrodes from the second singulation device to a second nest; a third in-feed conveyor, wherein the third in-feed conveyor is configured to transport singulated separator sheets from the third singulation device to a third nest; a transportation device having at least one vacuum-assisted gripping shoe, wherein the transportation device is configured to transfer an anode, a cathode, and a separator from the first, second, and third nests of each of the respective first in-feed conveyor, second in-feed conveyor, and third in-feed conveyor to a picking device using the at least one vacuum-assisted gripping shoe; wherein the picking device is further configured to pick the anode, the cathode, and the separator from the at least one vacuum-assisted gripping shoe of the transportation device using one of at least three gripping shoes coupled to the picking device; at least one battery stacking station adapted to receive at least one singulated anode, at least one singulated cathode, and at least one singulated separator material; wherein the at least one battery stacking station is adapted to be positioned at a battery stacking position and a battery removal position; and a removal device, adapted to remove a battery stack from the at least one battery stacking station when it is in a battery removal position.

In some embodiments, the transportation device is adapted to alternately transfer an anode and a cathode to the rotating picking device.

In some embodiments, the transportation device has one position in which it is simultaneously gripping an anode and releasing a cathode and one position in which it is simultaneously gripping a cathode and releasing an anode.

In some embodiments, the system further comprises quality inspection devices adapted to inspect the cathodes, the separators, and the anodes before they are transferred to the first, second, and third nests.

In some embodiments, the system further comprises quality inspection devices adapted to inspect the cathodes, the separators, and the anodes before they are transferred to the picking device.

In some embodiments, each of the first, second, and third nests further comprises an alignment device configured to align the electrodes and separators.

In some embodiments, the transportation device comprises an alignment device configured to align the electrodes and separators.

In some embodiments, each of the first, second, and third nests further comprises air bearings on which the electrodes are positioned.

In some embodiments, the system further comprises a second battery stacking station.

In some embodiments, the first battery stacking station and second battery stacking station further comprise a vacuum source that is fluidly coupled to the first battery stacking station and the second battery stacking station, wherein the vacuum source is adapted to exert a suction force on the battery stack that encircles the battery stack.

In some embodiments, each battery stacking station is positioned on a mechanical transportation device, and is thereby adapted to move along at least two axes that are perpendicular to each other.

In some embodiments, each battery stacking station comprises a movable side wall.

In some embodiments, the first, second, and third buffering devices are adapted to output a predetermined length of the film material in an index motion, the index motion comprising a rapid acceleration followed by a rapid deceleration.

In some embodiments, the first, second, and third buffer devices further comprises a suction plate comprising a vacuum source adapted to pull the film material towards it.

In some embodiments, the first, second, and third buffering devices further comprises a measuring device for determining a position of the film material.

In some embodiments, the first, second, and third singulation device provides an index motion that includes a complete stop of the film material and cuts the film material during the stop.

In some embodiments, the first, second, and third singulation device wherein the film material is adhered the at least three faces of the first, second, and third singulation devices using suction.

In some embodiments, the first, second, and third singulation device is configured to apply different amounts of suction to each of the at least three faces.

In some embodiments, the cutting device of the first, second, and third singulation devices is a blade.

Another aspect of the present disclosure generally relates to a system for transferring electrodes in a battery stacking system. The system comprises a first transportation device for transferring anodes and a second transportation device for transferring cathodes, a first nest for receiving the anodes and a second nest for receiving the cathodes, and a gripping device adapted to alternatively transfer an anode and a cathode from the respective nest to a subsequent station in the system.

According to another aspect, a system for transferring an electrode to a battery stack is provided. The system comprises a picking device comprising a surface adapted to adhere an electrode to its surface via vacuum, wherein the surface has a plurality of vacuum zones that can be individually controlled, and one processing device per vacuum zone, wherein each processing device is adapted to track its respective vacuum zone. The system further comprises a computing device associated with the picking device, adapted to monitor a position of each vacuum zone and transmit it to the processing device. The processing device is adapted to turn off its respective vacuum zone when that vacuum zone has reached a predetermined position.

According to another aspect, a system for battery stacking is provided. The system comprises a first battery stacking station adapted to receive anodes, cathodes and separator material, and a second battery stacking station adapted to receive anodes, cathodes and separator material. Each of the battery stacking stations is adapted to be positioned at a battery stacking position and a battery removal position. The system further comprises a removal device, adapted to remove a battery stack from a battery stacking station when it is in the battery removal position.

According to another aspect, a method for battery stacking and removal is provided. The method comprises stacking anodes, cathodes, and separator material on a first battery stacking station at a stacking position until a first battery stack has been produced and moving the first battery stacking station to a removal position, and moving a second battery stacking station to the stacking position. The method further comprises stacking anodes, cathodes, and separator material on the second battery stacking station until a second battery stack has been produced, and the first battery stack is removed from the first battery stacking station.

According to one aspect, a singulation device for cutting a film material into pieces is provided. The device comprises a body comprising at least two substantially flat faces) for receiving the film material, wherein each face is adapted to adhere the film material to the face, wherein the body is adapted to rotate around an axis. The singulation device further comprises a cutting device comprising a cutting edge, adapted to cut the film material while it is adhered to one of the at least two faces of the body. The body is adapted to rotate in an index motion comprising an acceleration followed a deceleration, and the cutting device is adapted to cut the film material during an index motion.

According to another aspect, a system for separating and cutting a film into pieces is provided. The system comprises a singulation device according to the first aspect, and a buffering device for transferring the film material to the singulation device, wherein the buffering device is adapted to receive the film material at a constant speed and output it to the singulation device at a varying speed.

According to another aspect, a method for cutting a film material into pieces is provided. The method comprises transferring the film material to a face of a singulation device comprising a body with at least two substantially flat faces for receiving the film material, wherein each face is adapted to adhere the film material to the face, wherein the body is adapted to rotate around an axis. The method further comprises rotating the body in an index motion comprising acceleration followed by a deceleration, thus transferring the film material from a first position to a second position. The method further comprises cutting the film material while it is adhered to one of the at least two faces of the body.

According to one aspect, a buffering device adapted to receive a film material at a constant speed and output the film material at a varying speed is provided. The buffering device comprises a first transportation portion adapted to transport the film material at the constant speed, adapted to receive the film material at the constant speed. The buffering device further comprises a second transportation portion adapted to transport and output the film material at the varying speed, wherein the varying speed has a maximum speed higher than the constant speed and a minimum speed lower than the constant speed. The buffering device further comprises a buffer portion in between the first and second transportation portions for accommodating the film material.

According to another aspect, a system for transferring a film material is provided. The system comprises a buffering device as disclosed herein, and a film dispensing device providing the film material at the constant speed. The system further comprises a film withdrawing device adapted to withdraw the film material from the buffering device at the varying speed.

According to another aspect, a method for transferring a film material from a film dispensing device providing the film material at a constant speed to a film withdrawing device withdrawing the film material at a varying speed is provided. The method comprises feeding the film material at the constant speed to a buffering device and receiving the film material at the buffering device. The method further comprises providing the film material to a buffering portion of the buffering device, until the amount of film material at the buffering portion is at least as much as is required in one film withdrawing operation. The method further comprises withdrawing an amount of film material in a film withdrawing operation comprising an acceleration followed by a deceleration, from the buffering device, such that an amount of film material withdrawn from the buffering portion is equal to the amount of film withdrawn by the film withdrawing device in one withdrawing operation, thus decreasing the amount of film material in the buffering portion.

In an embodiment, the battery stacking system includes a rotating transfer device that is adapted to alternately transfer an anode and a cathode to the rotating picking prism.

In an embodiment, the battery stacking system includes quality inspection devices that are adapted to inspect the cathodes, separators, and anodes before they are transferred to the rotating transfer device.

In an embodiment, the battery stacking system includes quality inspection devices that are adapted to inspect the cathodes, separators, and anodes before they are transferred to the rotating picking prism.

In an embodiment, the battery stacking system includes an alignment device on each of the first, second, and third in-feed conveyors, which is configured to align the electrodes and separators while they are on the conveyor.

In an embodiment, the battery stacking system includes an alignment device on each of the rotating transfer devices, which is configured to align the electrodes and separators while they are continuously in motion and being transferred to the rotating picking prism.

The present disclosure relates to a battery manufacturing device capable of creating a battery stack using a continuous singulated lamination process by successively controlling a plurality of parameters, including the above-mentioned novel features, such as (but not limited to), in various embodiments, the alignment of anode and cathode sheets, the output speed of in-feed conveyors, and the pressure applied to battery material. The battery manufacturing device includes various sensors, including but not limited to pressure sensors, alignment sensors, tension sensors, temperature sensors, vibrational sensors, and cameras to ensure precise stacking and quality control.

### BRIEF DESCRIPTION OF THE SEVERAL VIEWS OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 shows a system for transferring electrodes according to an embodiment.

FIGS. 2A-2C show different stages of an operation for releasing a battery stack material according to an embodiment.

FIG. 3 shows a battery stacking station according to an embodiment.

FIGS. 4-7B show a battery stacking system according to an embodiment.

FIG. 8 shows a singulation device according to an embodiment.

FIG. 9 shows a second view of the singulation device of FIG. 8.

FIGS. 10A and 10B show a body of the singulation device, according to another embodiment.

FIGS. 11A and 11B show a vacuum regulation system according to an embodiment.

FIG. 12 shows a system including the singulation device, according to an embodiment.

FIG. 13 shows steps of a method according to an embodiment.

FIG. 14 shows a system comprising a buffering device, according to an embodiment.

FIG. 15 shows a buffering device, according to an embodiment.

FIG. 16 shows the buffering device of FIG. 15, including a film material.

FIG. 17 shows one transportation portion of a buffering device, according to an embodiment.

FIG. 18 shows a block schematic of method steps, according to an embodiment.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, a possible industrial embodiment of the disclosure centered around an improved battery stacking system. This embodiment is described with detail sufficient to enable one of ordinary skill in the art to practice the disclosure. It is understood that each subfeature or element described in this embodiment of the disclosure, although unique, is not necessarily exclusive and can be combined differently and in a plurality of other possible embodiments because they show novel features. It is understood that the location and arrangement of individual elements, such as geometrical parameters within each disclosed embodiment, may be modified without departing from the spirit and scope of the disclosure. The disclosed apparatus can be modified according to known design parameters to implement this disclosure within these specific types of operation. Other variations will also be recognized by one of ordinary skill in the art. Therefore, the following detailed description is not to be taken in a limiting sense.

Briefly described, the present solution relates to systems, method and devices used in battery stack manufacturing. The solutions described herein may in some embodiments be combined and used the same system, and in some embodiments they may be separate from each other.

Anodes and cathodes are referred to collectively as electrodes. A collection of alternating anodes and cathodes with separator in between adjacent anodes and cathodes is referred to as a battery stack. Anodes, cathodes and separator are referred to collectively as battery material.

### System for Transferring Electrodes to a Battery Stack

As stated above, existing approaches to stacking electrodes and separator material have difficulty ensuring precise alignment across multiple layers, resulting in uneven pressure distribution, mechanical stress on electrodes and separators, performance degradation, internal short circuits, and thermal runaway. The existing approaches also have difficulty inspecting the electrodes and stack for placement accuracy due to manufacturing constraints related to using a continuous separator web. If the alignment of the layers is not correct, the stack will have to be trimmed, or the overall battery capacity will be reduced, which leads to higher manufacturing costs and wasted material. The stacking system 100 solves these issues by allowing for the continuous stacking of singulated electrodes and separator material while maintaining accuracy and manufacturing speeds not possible with existing methods.

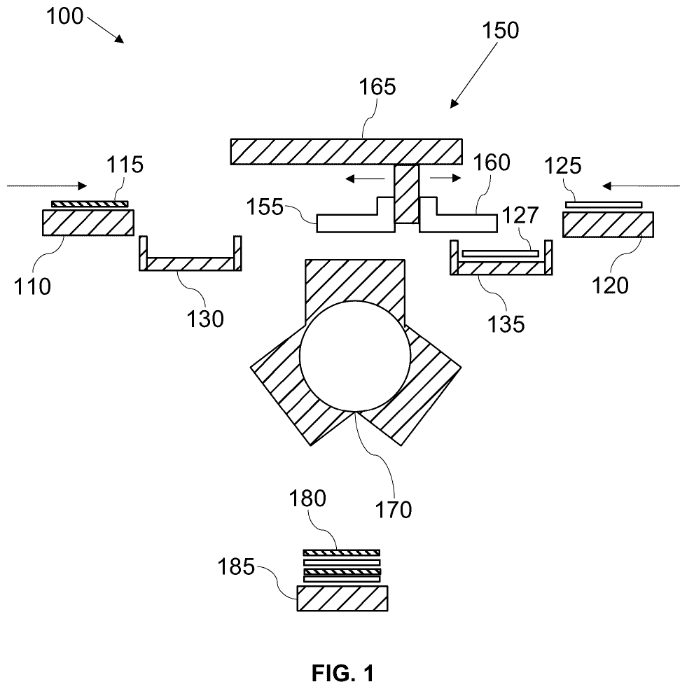

Looking now at FIG. 1, a system 100 for transferring electrodes to a battery stack is shown.

The system comprises a first transportation device 100 for transporting a first electrode 115 towards a picking device 170. The system further comprises a second transportation device 120 for transporting a second electrode 125 towards the picking device 170. The picking device 170 is adapted to pick up an electrode from the gripping device 150 and then deposit the electrode at a battery stack 180, positioned at a battery stacking station 185.

One of the electrodes 115, 125 is typically an anode, and the other one is cathode. The transportation devices 110, 120 may be any type of transportation device suitable for the system, such as a conveyor.

The in-feed conveyor systems, first transportation device 110 and second transportation device 120, for battery stacking are designed to transport singulated anode, cathode, and separator sheets from upstream processes to the transfer device 150 and rotating picking device 170 with high precision and synchronization. An example of a singulation device is disclosed below. There may be a singulation device for each in-feed conveyor for each of the anode, cathode, and separator. These conveyors contain one or more lanes or belts dedicated to different materials (anode, cathode, separator) to ensure seamless feeding into the stacking process. Equipped with features like vacuum-assisted gripping mechanisms, sensors, and alignment devices, these conveyors ensure that each component is correctly positioned and aligned before entering the stacking system 100. Advanced systems often integrate tension controls, speed adjustments, and robotic arms to handle delicate and thin materials, particularly separators, which are prone to deformation. Additionally, real-time quality checks such as optical or X-ray inspection systems can be incorporated along the conveyors to detect defects in materials before they reach the stacker, ensuring consistent quality and minimizing the risk of downstream issues.

Both transportation devices 120 are typically the same type of transportation device, but which type it is may differ between implementations. In embodiments wherein the transportation device is a conveyor, it may in some embodiments be a conveyor adapted to transport the electrodes using suction to keep them adhered to the surface of the conveyor. In some embodiments, the conveyor may be inverted and transport the electrode 115 on a bottom side rather than a top side. In embodiments with an inverted conveyor, some type of mechanism for adhering the electrode to the conveyor is required, which may be suction.

The system further comprises a first nest 130 adapted to receive the first electrode 115 and a second nest 135 adapted to receive the second electrode 125. In FIG. 1, there is one electrode 127 positioned in the second nest 135.

The nests are adapted to receive the electrodes from the conveyors. In some embodiments, there may be intermediate devices which facilitate the transfer from the transportation devices 110, 120 to the respective nests 130, 135. In some embodiments, Bernoulli grippers are positioned between the transportation devices 110, 120 and the respective nests, which employ suction to keep the electrodes from falling down towards the nests too early.

The nests 130, 135 are adapted to transfer the electrodes 115, 125 to a gripping device 150. The gripping device comprises a first gripper 155 and a second gripper 160, adapted to pick up the electrodes from the nests 130, 135 and transport them to the picking device 170.

The gripping device 150 is adapted to move back and forth between the nests 130, 135, in order to alternately pick up an anode and a cathode and deliver them to the picking device 170.

The grippers 155, 160 may employ suction in order to pick up the electrodes 115, 125 from the nests. The grippers 155, 160 may comprise vacuum chucks. The grippers 155, 160 may further be adapted to use a stream of air to push the electrodes away from the grippers 155, 160 when releasing them to the picking device 170.

The nests may comprise air bearings on a bottom surface, which are adapted to receive the electrodes from the conveyor and/or any optional intermediate devices. In some embodiments, the nests may be adapted to employ suction and/or air at different positions in the nest, such that some parts or zones of the nest provides air as a cushion for the electrode, while other parts or zones of the nest employ a vacuum for adhering the electrode to the nest. This may be achieved by vacuum preloaded air bearings with switchable vacuum zones. This may be achieved by vacuum-preloaded air bearings with switchable vacuum zones. In an embodiment, the switching between generating a vacuum or a jet or air is achieved using plumbed-in baffles within the nests.

The nests may be adapted to move back and forth along a vertical axis, i.e. up and down. An electrode 127 is received at a nest when the nest is in a bottom position, and the bottom of the nest is moved upwards in order to be at a top position when a transfer is made to the gripper 160. In some embodiments, the nests move up and down by a shaft positioned on an eccentric lobe, which rotates eccentrically around an axis and moves the nest up and down during one revolution.

In some embodiments, the nests 130, 135 comprises an alignment mechanism for aligning the electrodes. It may be beneficial to have the electrodes positioned at the same, or substantially the same, position each time a transfer to the gripping device 150 is made. In some embodiments, the alignment mechanism comprises one or multiple brushes that are pushed against one or multiple sides of the electrode. In an embodiment, the alignment device includes one or more wheels that are used to push or pull one or more sides of the battery material to maintain a predetermined. In an embodiment, the alignment device includes one or more vacuum or jet regions that are used to push or pull one or more sides of the battery material to maintain a predetermined alignment.

After the electrodes 115, 125 have been transferred to a gripper 155, 160 of the gripping device 150 from the respective nest. 130, 135, the gripping device moves towards the picking device 170. When the gripper 155, 160 holding the electrode reaches the picking device, the electrode is handed over to the picking device 170. In some embodiments, the electrode is gripped by suction by the picking device. In some embodiments, the suction of the gripping device 150 is turned off when the picking device 170 comes in contact with the respective gripper 155, 160. In some embodiments, the picking device 170 employs a stronger suction than the grippers 155, 160, which enables it to pick the electrodes 115, 125 from the grippers 155, 160 without the releasing their suction.

In some embodiments, the electrodes may be handed over to another.

The gripping device 150 may in some embodiments be positioned such that one gripping device 160 is gripping an electrode 127 in the nest, the other gripping device is in a position to release another electrode to the picking device 170. In such embodiments, the gripping device 150 is stopped or moving very slowly at both gripping and releasing positions. As will be understood, there are in such embodiments two mirrored positions for the gripping device 150, one where it is picking an anode and simultaneously releasing a cathode, and one position where it is picking a cathode and simultaneously releasing an anode.

In some embodiments, the electrodes may be handed over to another subsequent station of the battery stacking system than a picking device 170. In some embodiments, the electrodes may be transferred directly from the gripping device 150 to a battery stacking station 185.

In some embodiments, the picking device comprises multiple faces, and is adapted to rotate, optionally eccentrically, in order to first pick up an electrode from the gripping device 150, before depositing the electrode at the battery stacking station 185.

In some embodiments, the picking device 170 is further adapted to pick and release separator material, which is positioned in between anodes and cathodes on the battery stack. The separator material may be transported together with the electrodes, or it may be transported separately. In some embodiments, the picking device 170 picks up a layer of separator first, and then picks an electrode on top of the separator material, and then transfer both the separator material and the electrode on the battery stack 180 at the same time.

When the separator material is transported independently, the rotating picking device may be configured to pick a sheet of singulated separator material on alternating faces or shoes from electrodes 115 and 125 from the face of an upstream singulation region utilizing vacuum and air jets to hold and place the singulated sheet. In some embodiments, the rotating picking device 170 picks up multiple layers simultaneously, e.g., an electrode and a separator. There are two different picking strategies if the rotating picking device 170 is configured to pick up multiple layers. The first is the “conventional” pick, where the rotating picking device 170 is configured to pick a layer of separator first. Then, an electrode is on top of the separator material, and then transfers both the separator material and the electrode on the battery stack 180 at the same time. This strategy relies on the porosity of the separator. If the porosity is too low, the electrode will not be picked up at high speeds.

The second picking strategy is the “inverted” pick, the inverted pick strategy uses a high flow, “leaky” end effector to pick the electrode first and the separator second. The high-flow end effector allows the separator to be picked and securely held due to the constant airflow around the edges of the electrode which creates a suction force. Using the inverted pick method is porosity independent, thus allowing non-porous separators to be picked. This allows the stacking system 100 to handle a greater range of battery topologies, including prismatic, pouch-shaped, solid-state, or lithium foil-based.

In some embodiments, the system further comprises rejection mechanisms for rejecting electrodes that are faulty or misaligned. The system may further comprise inspection means, such as optical cameras, for determining if an electrode is faulty or misaligned. Such rejection mechanisms are preferably positioned between the transportation devices 110, 120 and the respective nests 130, 120. In some embodiments, the rejection mechanisms are in the form of reject chutes, into which the electrodes are dropped. In case the transportation devices 110, 120 are inverted conveyors using suction to adhere the electrodes to them, rejecting an electrode may comprise releasing the suction, and possible use an air jet to also push the electrode, towards a reject chute positioned directly below the respective transportation device 110, 120.

Battery quality is a measurement of electrode placement accuracy. Quality inspection systems for battery stacking ensure that the electrodes (anodes and cathodes) and separators are properly aligned and defect-free before and during the stacking process. These systems often employ advanced technologies such as optical, X-ray, or laser-based sensors to detect misalignments, foreign particles, or material defects that could compromise battery performance and safety. Real-time monitoring is essential, as even minor deviations can lead to short circuits, reduced capacity, or thermal events. Inspection systems may also include impedance spectroscopy and other electrical testing methods to verify the integrity of the stacked layers. Integrated with automation, these quality control systems enable continuous monitoring and corrective actions, minimizing defects and ensuring high reliability in the final battery stacks used in electric vehicles, energy storage, and other applications. In an embodiment, the quality inspection device includes an optical camera (not shown) for determining if an electrode is faulty or misaligned. The control box (not shown) may be configured to receive real-time images of the edges of the battery material to detect misalignments and defects. If a misalignment or defect is detected, the control box sends a signal to either the rejection device, the battery stacking station 185, or the battery stack removal system to initiate a rejection process of the individual sheet of battery material or the entire stack

In some embodiments, the quality inspection system is configured to generate a digital twin of the entire battery stack throughout the entire stacking process. Using a digital twin in quality inspection for battery stacking systems offers numerous benefits by creating a real-time, virtual replica of the physical manufacturing process. This advanced method allows manufacturers to simulate, monitor, and optimize production without interrupting the workflow. A digital twin can track and analyze data from various sensors in the battery stacking system, providing insights into potential defects, misalignments, or inconsistencies in the stacking of electrodes and separators. Manufacturers can make immediate adjustments by predicting issues before they occur, minimizing downtime, and reducing waste. Additionally, the digital twin enhances predictive maintenance by monitoring the health and performance of machinery, preventing breakdowns. Overall, this method improves the precision, efficiency, and reliability of the battery manufacturing process, ensuring higher quality control standards and reducing production costs.

In some embodiments, the system further comprises electrode cleaning stations, upstream of the respective transportation devices 110, 120. The cleaning stations are adapted to clean, and optionally also deburr the electrodes prior to transporting them to the picking device.

Such electrode cleaning stations may comprise two air bearings opposite to and close to each other, such that the electrodes are transported through the two air bearings in order to clean and deburr them using the air pressure. The distance between two such air bearings is preferably roughly the same or slightly larger than the electrodes, which may be less than 2 microns.

The cleaning stations may in some embodiments include other ways of cleaning the electrodes, such as ultrasonic cleaning, solvent baths, or electrocleaning. The cleaning stations may also comprise other means of deburring the electrodes, such as mechanical brushing, abrasive blasting, or chemical deburring.

### Solutions for Holding and Releasing Battery Material

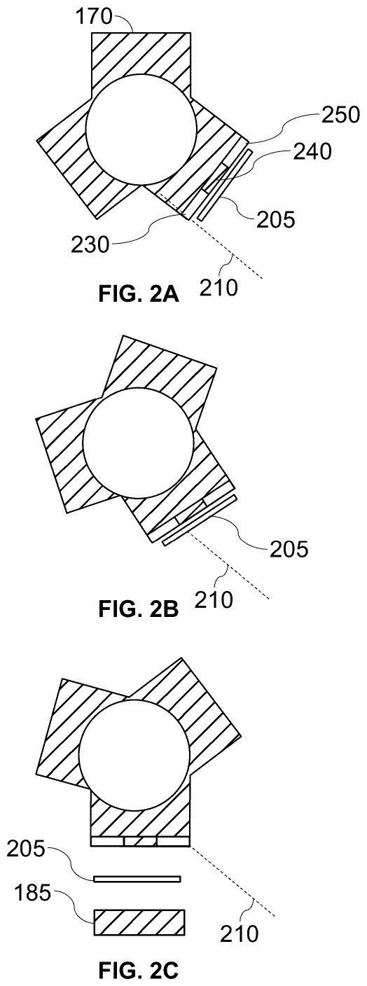

The disclosure further relates to methods and systems for holding and releasing battery material, which may be both electrodes and separator material. Such methods and systems may be implemented in, e.g., the electrode transferring system described above. FIG. 2 is the main figure for this solution, but reference to the system of FIG. 1 may be made when relevant.

When transferring an electrode from, e.g., the picking device 170 to the battery stacking station 185, a solution may be employed in which the electrode is released in several steps, i.e., gradually, rather than all at once. By releasing the electrode one part at a time, a smoother and more accurate transfer may be achieved, which also decreases the risk of damaging the electrode. In the embodiment described below, the gradual transfer of an electrode is performed by a picking device comprising vacuum means for adhering the electrode to a surface of the picking device.

In order to achieve a gradual transfer, the surface of the picking device comprises multiple zones in which vacuum may be applied individually. Each vacuum zone comprises a device for keeping track of the position of the specific zone.

In order to keep track of individual zones, standalone devices may be used. Such devices may be standalone processing devices comprising processing circuitry, such as a microcontroller or digital signal processor, which may comprise one or more programmable processors, application-specific integrated circuits, field programmable gate arrays or combinations of these.

On example of such a device is an output compare device, which is adapted to compare a value against another value and optionally perform an action when a specific value is detected or exceeded.

Further, a predetermined position when the vacuum of the picking device is adapted to be turned off may be registered in the standalone processing device. When this predetermined position is reached for the specific zone, the standalone device for that zone signals that the vacuum is to be turned off. The same applies for the standalone device of the next zone, and then the next, and so one.

In some embodiments, the standalone device is adapted to transmit its position to another processing or computing device. Such a computing device may be associated with the picking device 170, which keeps track of the picking device position. The computing device of the picking device 170 may be adapted to turn on and off the vacuum zones. Data between processing devices and/or computing devices is preferably transmitted wirelessly.

This is illustrated in FIGS. 2A-2C. In FIG. 2A, the picking device adheres electrode 205 to its surface using vacuum. The face of the picking device holding the electrode 205 comprises a first vacuum zone 230, a second vacuum zone 240, and a third vacuum zone 250. The same applies for FIGS. 2B and 2C but references are omitted.

As the picking device rotates from the position in FIG. 2A towards the release position in FIG. 2C, it passes the predetermined level 210 for when the vacuum is to be turned off. Since each zone 230, 240, 250 is associated with its own processing device, the respective processing device keeps track of its own position relative to the predetermined position 210, and turns off the vacuum when that position is reached.

This entails that in FIG. 2B, the first vacuum zone 230 has been turned off, and the second vacuum zone 240 is about to be turned off. When the picking device 170 reaches the position of FIG. 2C, the third zone 250 has also been released, which results in that the electrode 205 is released from the picking device towards battery stacking station 185. In some embodiments, it may be released with virtually no distance to the battery stack, and in some embodiments it may be released and fall some distance before it reaches the battery stack.

In some embodiments, the picking device 170 may further be adapted to use air for pushing the electrode 205 away from the picking device, as it is being released. This may entail that when the respective zone 230, 240, 250 passes the predetermined position 210, the vacuum is turned off and an air jet is turned on.

### Battery Stacking Stations and Battery Removal Devices and Methods

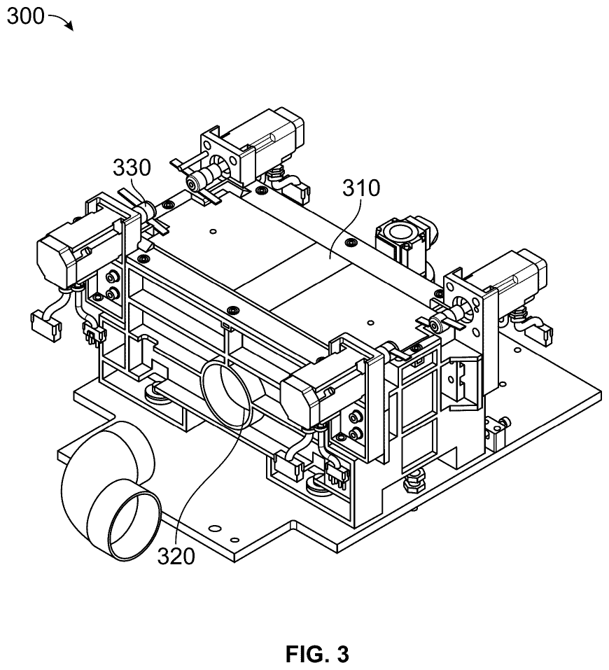

FIG. 3 shows a battery stacking station 300 according to an embodiment. The battery stacking station 300 may be the battery stacking station 185 of FIG. 1 or FIG. 2C.

The battery stacking station 300 comprises a platform 310, onto which a battery stack is to be positioned. The battery stack typically comprises alternating layers of anodes and cathodes, with separator material in between. The separator material may be in the form of a continuous sheet that is folded between the electrodes, or it may be in the form of separate sheets.

The battery stacking station 300 further comprises four walls, surrounding the platform, and a hollow interior.

In some embodiments, the platform 310 is adapted to lower as layers of battery material are placed on it. The layers of battery material may be positioned on the platform 310 by a picking device 170. In some embodiments, the station 300 may comprise an elevator mechanism which can lower and raise the platform 310. The elevator mechanism may in some embodiments comprise a screw positioned inside of the station 300, below the platform 310, such as a jackscrew.

The battery stacking station 300 further comprises a vacuum port 320, for connection to a vacuum source. When the vacuum source is connected to the vacuum port 320, a vacuum is created inside of the battery stacking station, which adheres the battery material to the platform 310.

By using a vacuum to suction and adhere the battery material to the platform 310, a more robust system which is less prone to misalignment and other position errors may be achieved without using mechanical solutions that may be prone to damage the battery stack. It may also help stabilize the battery stack and simplify the process of positioning new battery material on it.

In some embodiments the station 300 may further comprise flexible clamping means 330 intended to contact the top layer of the battery stack in order to further fixate the battery stack on the platform 310. The flexible clamping means may comprise two flaps positioned on a rotating body, with the two flaps extending in opposite directions. The body is adapted to rotate 180 degrees when the next layer of battery material is placed on the stack, such that the flap holding down the battery stack is removed when the top layer is placed, and the other flap rotates to be on top of the newly placed layer.

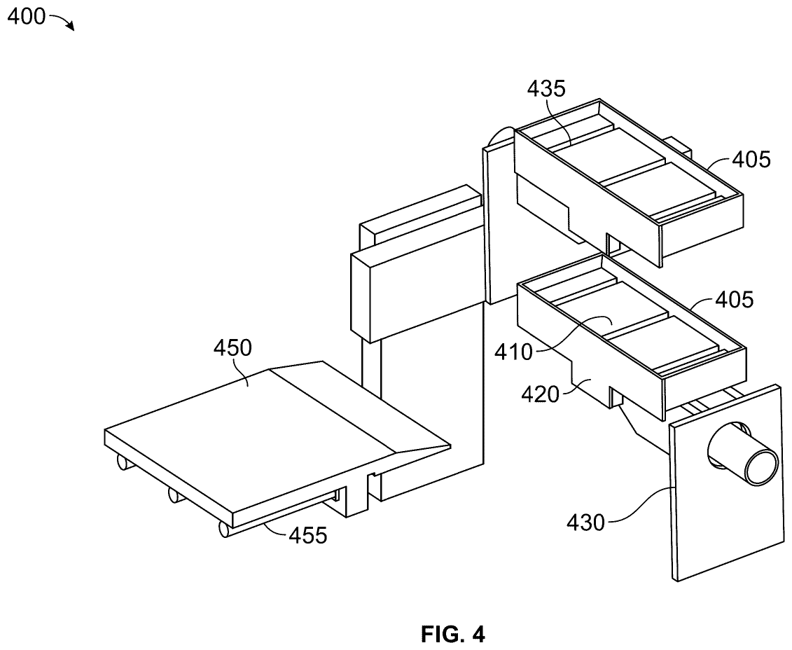

FIGS. 4-7 show a system 400 for battery stack removal, comprising two battery stacking stations 405 of a different embodiment than shown in FIG. 3, and shows method steps for battery stack removal using two such battery stacking stations 405. All features are not referenced on both battery stations 405, but they typically comprise the same features. In some embodiments, the battery stacking stations 405 are identical.

The battery stacking stations 405 each comprise a floor 410 onto which a battery stack is placed. It further comprises a front wall 420, which can be lowered. The stations 405 may further comprise a hollow interior and comprise or is connected to a vacuum source, which creates a suction adhering the battery stack to the floor 410. In some embodiments, the floor 410 is stationary and cannot be lowered or raised, and so are the other three walls apart from the front wall 420.

The system further comprises a stack removal device 450, comprising prongs 455 adapted to extend from the device 450, adapted to be positioned below a formed battery stack.

The battery stacking stations 405 may in some embodiments comprise recesses or channels 435 in the floor adapted to receive the prongs 455, positioned below the floor 410 and thus enable the prongs 455 to be positioned below the floor 410 where the bottom layer of a battery stack is positioned.

The stations 405 may be positioned on arms or other mechanical transportation devices 430 adapted to transport the battery stacking stations 405 along at least two axes. In some embodiments, the stations 405 may be moved freely in space by the transportation devices 430.

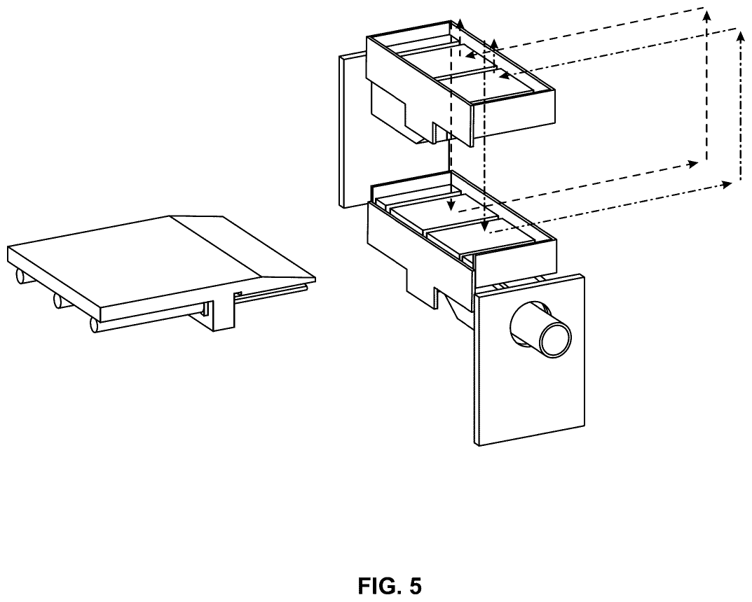

FIG. 5 shows how the battery stations 405 may be moved in up, down, and laterally in two opposite directions, in order to position them in the system. The stations have at least four positions, a top right, bottom right, top left and lower left position. In some embodiments, the battery stations 405 may be freely and continuously positionable between any of these positions.

In some embodiments, the top right position is the position in which the battery stack is positioned onto the stations 405, and the bottom right position is the position in which the removal device 450 removes a completed battery stack from a station 405.

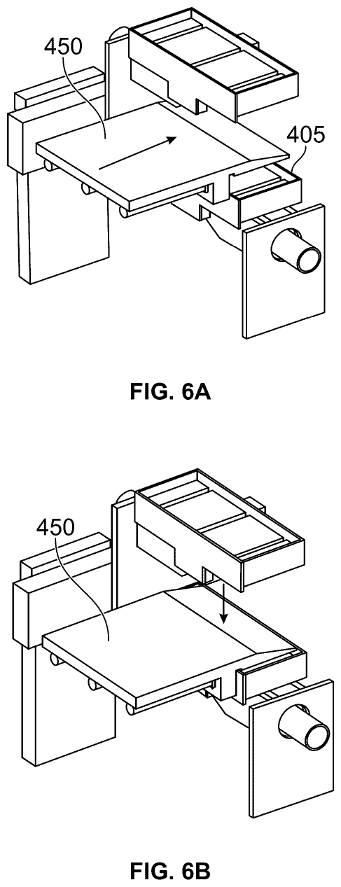

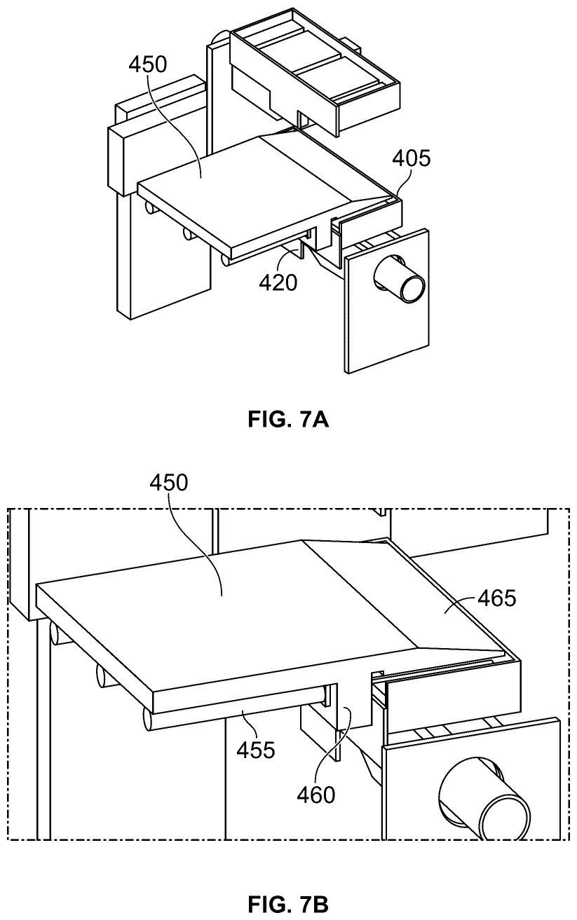

FIGS. 6A, 6B, 7A and 7B show how the stack removal device 450 is used to remove a battery stack from a battery stacking station 405.

First, the removal device 450 is moved towards the bottom station 405, and is positioned above it, as shown in FIG. 6A. Then, the stack removal device 450 is moved relative to the bottom 405 station, such that it is pressed down on the top of the battery stack (not shown) which is positioned on battery stacking station 405, as shown in FIG. 6B. In some embodiments, this entails lowering the stack removal device 450, and in some embodiments it entails raising the station 405.

Then, the front wall of the battery stacking station 405 is lowered to a bottom position, as shown in FIG. 7A. In some embodiments, the removal device 450 may comprise a front barrier 460 adapted to be positioned such that it keeps the vacuum pressure inside of the station 405 even when the wall 420 is lowered.

Following that, the prongs 455 of the removal device 450 are extended forward, and positioned in the recesses 435 of the battery stacking station 405. When the prongs 455 have been positioned, the front 465 of the removal device may press down on the battery stack in order to keep it tightly positioned.

Then, the battery removal device 450 may retract from the battery stacking station 405 and move the battery stack to another position, for storage or further transport.

According to an aspect, a system for battery stacking and removal is provided. It comprises two battery stacking stations 405, each comprising a floor, three stationary walls and a movable wall 420. The system further comprises a battery removal device 450, comprising means for gripping and moving a battery stack from a battery station.

Throughout this document, there are multiple different devices that use suction in order to adhere electrodes and/or separator material to them. Such suction may be achieved using differential pressure, which may be achieved by use of vacuum.

The suction may in some embodiments be replaced by other means of adhering a material to a surface. Such means may be, e.g., mechanical clamping means, electrostatic means, tacky or sticky surfaces, and similar solutions.

### Singulation Device

Briefly described, the present solution relates to a device for cutting a film material into pieces, herein called a singulation device. The device comprises a body with at least two faces which is adapted to rotate around an axis, wherein each face is adapted to receive the film material and adhere the film material to the face. The singulation device further comprises a cutting device adapted to cut the film material while it is adhered to one of the faces. The body is adapted to rotate in a motion comprising acceleration followed by deceleration, which may include a complete stop, and the cutting device is adapted to cut the film material after the deceleration. When rotating, the singulation device is adapted to withdraw an amount of film material, wherein one withdrawing and/or rotating operation usually withdraws an amount of film material corresponding to the size of one of the faces of the device. After the film material has been cut, it may be handed over to another device for transporting it to the battery stack. The acceleration and deceleration of the index motion is generally a rapid acceleration and deceleration, in order to achieve high speeds of the singulation device and the system in which it operates.

The present disclosure builds upon a realization that cutting singulated sheets of separator material at very high speeds can be highly beneficial when it comes to manufacturing battery stacks of prismatic batteries. Due to how difficult the separator is to handle, other current solutions involve laminating or otherwise treating it in order to make it easier to handle. However, cutting it into pieces at the same speed as the battery is being stacked can improve the battery manufacturing process and obviate the need for lamination or similar processes.

In order to enable very high manufacturing speeds, e.g. 0.2 seconds per battery layer, the separator needs to be singulated and cut at this speed as well, i.e. maximum 0.2 seconds per singulated sheet. Thus, the present solution aims to provide a device which can not only singulate and cut a separator material, but which can do so at very high speeds.

For the purpose of this disclosure, a film material is a thin and at least somewhat flexible material, wherein the material may be e.g. nonwoven fibers, polymer films, and naturally occurring substances such as rubber and asbestos. The film material may be in the form of a sheet, a web or a mat and may comprise directionally or randomly oriented fibers. The film material may comprise single or multiple layers of material.

For the purpose of this disclosure, an index motion is a motion intended to position something in a specific position, usually with high precision. The most common index motion referenced in this disclosure is a repeating motion comprising acceleration, which may be a rapid acceleration, followed by deceleration, which may be a rapid deceleration. The index motion may further include a complete stop after the deceleration. In some embodiments, one iteration of the index motion comprises a 90 degree rotation. In some embodiments, the index motion is a motion which comes to a complete stop at regular intervals.

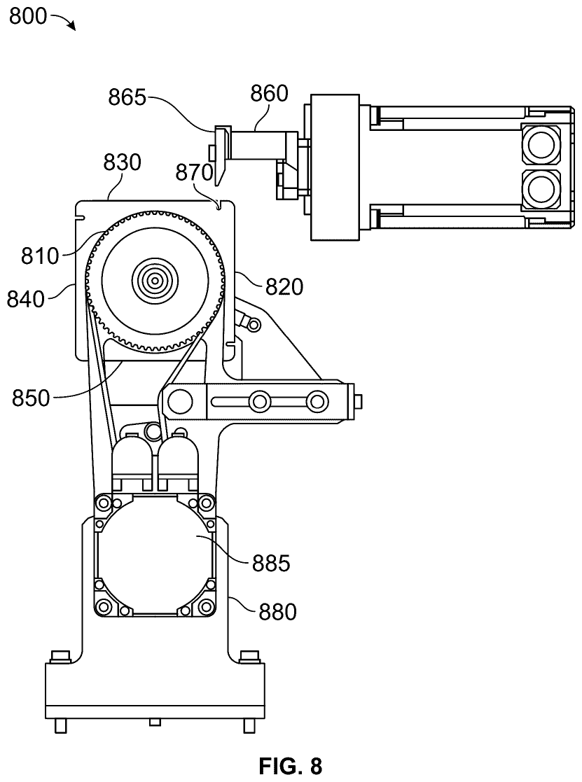

Looking now at FIG. 8, one embodiment of a singulation device 800 is shown.

The singulation device comprises a body 810, comprising four substantially flat faces 820, 830, 840, 850. In some embodiments, the body 810 may comprise more or fewer faces, as long as there are at least two faces. Typically, the faces of the body 810 are flat or substantially flat. In some embodiments, the corners of the faces are rounded in order to avoid breaking the film material.

In some embodiments, the device 800 may comprise six faces. In some embodiments, all of the faces have the same shape and size, and in some embodiments the faces may differ in size and/or shape.

Although the faces 820, 830, 840, 850 may be identical and change positions as the body 810 of the singulation device rotates, they will for the purpose of FIG. 8 be referenced as first face 820, second face 830, third face 840 and fourth face 850. The reference numerals 820, 830, 840, 850 will also be referenced interchangeably as first position 820, second position 830, third position 840 and fourth position 850.

At least one of the positions of the faces of the singulation device is a cutting position in which the film material is adapted to be cut. At least one of the positions is a receiving position adapted to receive the film material from a film transferring device or from a buffering device. In some embodiments, at least one position is an output position adapted to hand the film material off to a picking device after it has been cut. In some embodiments these positions may overlap, especially in embodiments wherein the singulation device comprises few faces, such as two. For example the first position may be both a receiving position and a cutting position, and/or the second position may be both a cutting position and an output position.

The faces 820, 830, 840, 850 are adapted to receive a film material which is being fed from a transferring device. The faces are further adapted to adhere the film material to the faces.

In some embodiments, each face 820, 830, 840, 850 is adapted to adhere the film material to it by suction. The suction may be provided by a vacuum source connected to the singulation device. In some embodiments, the faces may be adapted to adhere the film material by other means, such as electrostatically, mechanically or by using sticky or tacky surfaces.

In some embodiments, the singulation device is adapted such that each face may be controlled individually with respect to adhering the film to the respective face. In some embodiments where the adhering is achieved by suction, the amount of suction provided can be adjusted for each face individually. In some embodiments, the singulation device 800 is adapted such that the adhering of film material is either on or off for all faces at the same time. In embodiments wherein the adhering is accomplished via suction, it may entail that all faces are provided with the same amount of suction.

The body 810 is adapted to rotate around a central axis. The singulation device is typically adapted such that the body 810 rotates symmetrically around the axis, but in some embodiments the body 810 may rotate asymmetrically as well.

In some embodiments, the body 810 rotates in an index motion, such that it first accelerates relatively quickly from a standstill and the decelerates relatively quickly in order to position the film material for cutting and/or for being picked up by a picking device. The deceleration is typically followed by a complete stop, but in some embodiments it may comprise a slow rotation speed without ever stopping completely. In the embodiment of FIG. 8, one rotation operation, comprising one index motion, would rotate the body 90 degrees, such that a position of the first face 820 changes to the second position 830, the second face 830 changes to the third position 840, and so on.

The singulation device 810 further comprises a cutting device 860. The cutting device 860 may in some embodiments be incorporated into the same structure as the body 810 of the singulation device, and in some embodiments, such as the one shown in FIG. 8, the cutting device is external to an unconnected to the body 810.

The cutting device 860 comprises a cutting edge 165 adapted to cut the film material while it is being adhered to a face of the singulation device 800. In some embodiments, the cutting edge 865 may be a physical cutting edge such as a knife or a sharp edge. In some embodiments, the cutting edge 865 may be a laser or another type of energy source. In some embodiments, the cutting edge 865 may comprise a hot knife or a hot wire.

In some embodiments, each face 820, 830, 840, 850 may comprise an internal cutting device, which cuts the film material from the inside with respect to the body 810. By having an internal cutting device on each face, it is easier to cut the film material during motion of the singulation device, which may be beneficial in some implementations.

In some embodiments, each face 820, 830, 840, 850 of the singulation device 800 comprises a feature 870 adapted to receive the cutting edge 865 of the cutting device 860. In the embodiment shown in FIG. 8, the feature 870 is an indentation adapted to receive the physical cutting edge 865.

In the embodiment shown in FIG. 8, there are four different positions 820, 830, 840, 850 for the film material, one for each face. The process of rotating the body 810 of the singulation device and what this entails will now be elaborated on, based on the embodiment shown in FIG. 8.

The first position 820 is the first face on which the film material is transferred when the singulation device 800 rotates. When the first film material is being pulled onto the first face 820, it is adhered to the first face 820 by the singulation device, e.g. by use of suction. The body 810 is then rotated, such that the film material that was positioned at the first face 820 becomes positioned on the second face 830, and new film material is withdrawn from the transferring device onto the first face 820. When the film material is positioned on the second face 830, it is cut by the cutting edge 865 of the cutting device 860.

The body 810 then rotates again, transferring the film material from the second face 830 to the third face 840. Since the film material was cut at the second face 830, it is now no longer part of a web or continuous sheet of material, and can be transferred. In some embodiments, the film material is transferred to another device adapted to pick the film material from the third face 840.

Then the body 810 rotates again, and if the film material was transferred at the third face 840, there is no film material present at the fourth face 850. However, in some embodiments, the singulation device 800 may be adapted to transfer the film material from the fourth position.

In some embodiments, transferring the film material, from either of the third or fourth faces, comprises releasing the adhering of the film material to the face. In case it is adhered by suction, this would comprise releasing or lessening the suction.

In some embodiments where the film material is transferred at the third 840 or fourth position 850, the suction may simply be released and the film material would fall down to the transferring device.

In some embodiments, the singulation device 800 may further comprise a mechanism for rejecting faulty or damaged pieces of film material, after it has been cut. Such a mechanism may comprise using air to push the film material away from the face, after it has been cut. Typically, such a rejection is performed at the second 830 or third 840 position, or in between the second and third positions. The air used to push the film material away may also be generated using the same source which applies suction to the faces of the body 810, for example the suction may be reversed into positive pressure in order to blow off the sheet.

In some embodiments, the singulation device 800 further comprises a base 880, on which the body 810 is positioned. In some embodiments comprising a base 880, the singulation device 800 may be adapted such that the body 810 can pivot and/or deflect relative to the base 880. This may be achieved by a deflection mechanism. By having such a mechanism, transfer of the film material to a picking device after it has been cut may be facilitated, in case the picking device physically contacts the singulation device 800 when picking up the film material.

In some embodiments, the base 880 may comprise a motor 885, adapted to rotate the singulation device and optionally perform other operations as well. In some embodiments, the motor may be positioned at other places, such as inside the body 810.

In some embodiments, each face 820, 830, 840, 850 of the body 810 can be deflected individually, in order to allow for a picking device to pick the film material without colliding or risk interfering with the singulation device. In some embodiments, such deflection may be accomplished by spring means associated with each face. In some embodiments, deflection may be accomplished by foam or other resilient materials. The foam may either be provided on the faces, such that it is contact with the separator material, or it may be provided behind the surface portion of the faces.

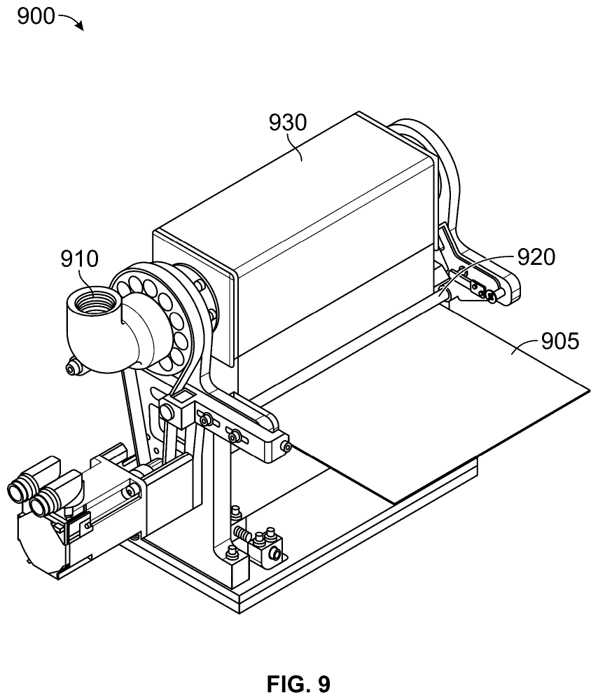

Looking now at FIG. 9, a different view of the singulation device 800 of FIG. 8 is shown. FIG. 9 also shows the film material 905 being fed onto the singulation device 800. The film material 905 may be fed from any source able to output the film material to the singulation device 800 without breaking or damaging the film. Due to the index motions used in embodiments of the singulation device comprising rapid acceleration, it may be necessary to withdraw the film material from a source with low or no inertia and/or friction. In some embodiments, the film material is withdrawn from a buffering device adapted to output the film material specifically to the singulation device.

As described previously, the singulation device 800 may use suction in order to adhere the film material to the faces 820, 830, 840, 850 of the body 810. FIG. 9 shows a tube 910 which may be connected to a vacuum source, which can be used to regulate the suction of the faces.

In some embodiments, the singulation device 800 may further comprise an alignment bar 920, which ensures that the film material 905 is fed onto the body 810 of the singulation device 800 in an optimal way.

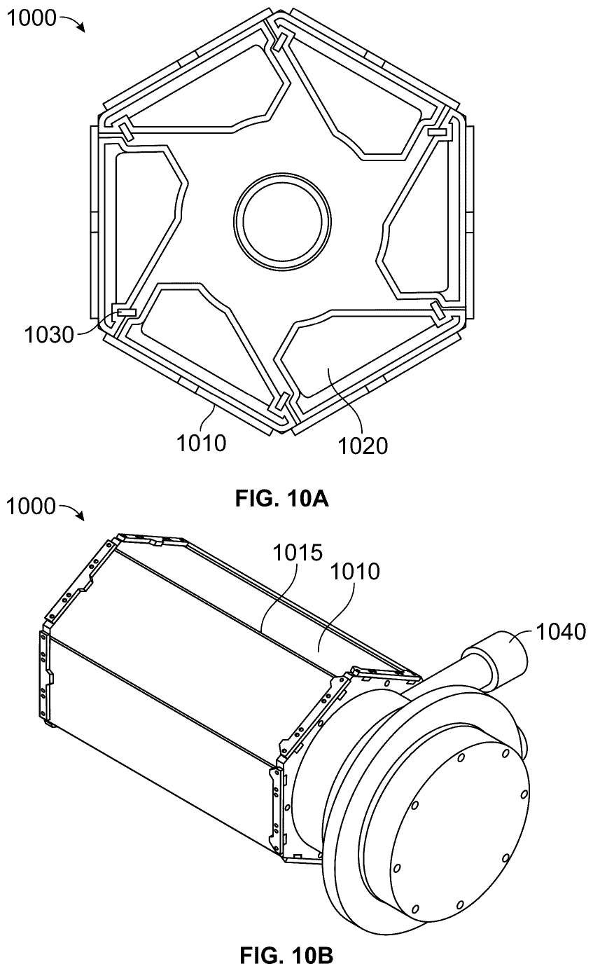

Looking now at FIG. 10A, an alternative embodiment of a body 1000 of the singulation device 800 is shown.

In this embodiment, the body 1000 comprises six faces 1010. As with the embodiment with four faces, the adhering of film material to a single face may be accomplished individually or collectively for all faces, depending on the implementation.

In some embodiments, each face of the body 1000 is able to deflect inwardly by use of one or multiple springs.

In some embodiments, each face of the body 1000 comprises a feature 1010 adapted to receive a laser beam or similar, in case the cutting edge 865 comprises a laser. The feature 1010 may simply deflect the laser beam in such a way that it doesn't risk damaging the body 1000.

In some embodiments, including both the ones shown in FIG. 8 and FIG. 10, the surface material of the face of the body of the singulation device, i.e. the surface on which the film material is positioned and adhered to, is made of any type of plastic material, aluminum, or titanium. In some embodiments, the material may be glass impregnated nylon.

FIG. 10B shows another view of a six-sided singulation device 1000, showing the faces 1010 as well as a recess 1015 in between each face through which the cutting edge of the cutting device may be employed in order to cut the film material. FIG. 10B further shows a vacuum supply 1040 for providing suction to the faces 1010.

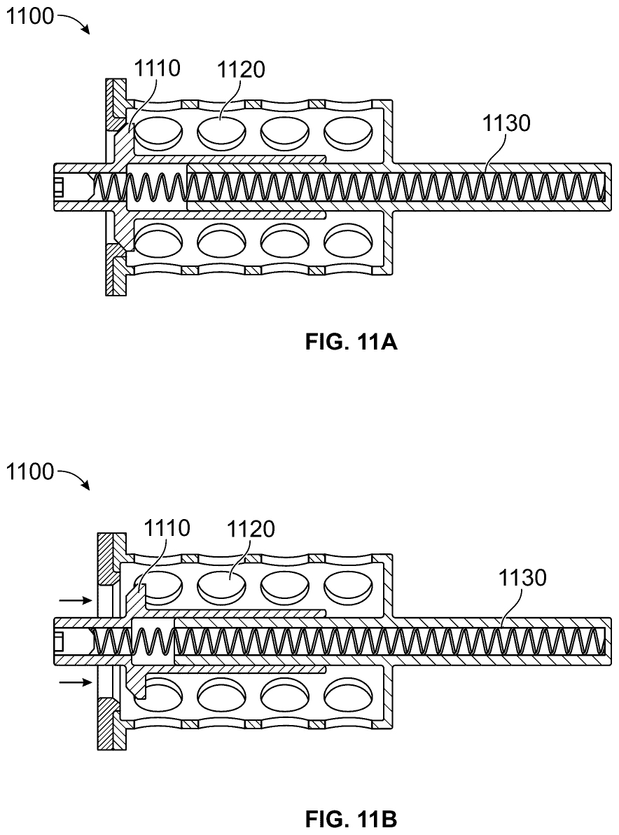

Looking now at FIGS. 11A and 11B, a mechanism for regulating the suction of the faces of the body used to adhere the film material will now be described. FIG. 11A shows a closed position where no air is let in, and FIG. 11B shows an open position in which air is let in.

The mechanism may be used regardless of the number of faces of body and it may be used either for all faces simultaneously, or for each face individually. The mechanism is preferably positioned on the inside of the singulation device body 810. As will be understood, the body 810 may comprise one or a plurality of vacuum regulation mechanisms 1100.

The mechanism 1100 comprises a valve 11710 which may be opened and closed in order to adjust the amount of air or other gas that is let in, which in turn regulates the amount of vacuum. The valve 1110 may be continuously positionable between an opened and a closed position, such that the amount of air that is let in can be continuously adjusted and not only have two discrete positions.

The mechanism further comprises a number of holes 1120, adapted to let air or gas through in order to apply the suction to the faces of the singulation device. The holes 1120 are generally positioned on the surface of the faces of the singulation device.

The mechanism may further comprise a spring 1130, which may automatically or semi-automatically adjust the amount of air that is let in, thereby regulating the vacuum. When the amount of vacuum inside the mechanism increases, the spring 1130 is contracted, which decreases the extension of the spring and which opens the valve 1110, which in turn lets more air into the mechanism. When more air is let in, the amount of vacuum decreases, which decreases the pressure on the spring and lets the spring extend, which closes the valve 1110 and increases the amount of vacuum in the mechanism.

By having an automatically adjustable mechanism for regulating the vacuum, a more robust and efficient application of suction on the faces of the singulation device may be achieved.

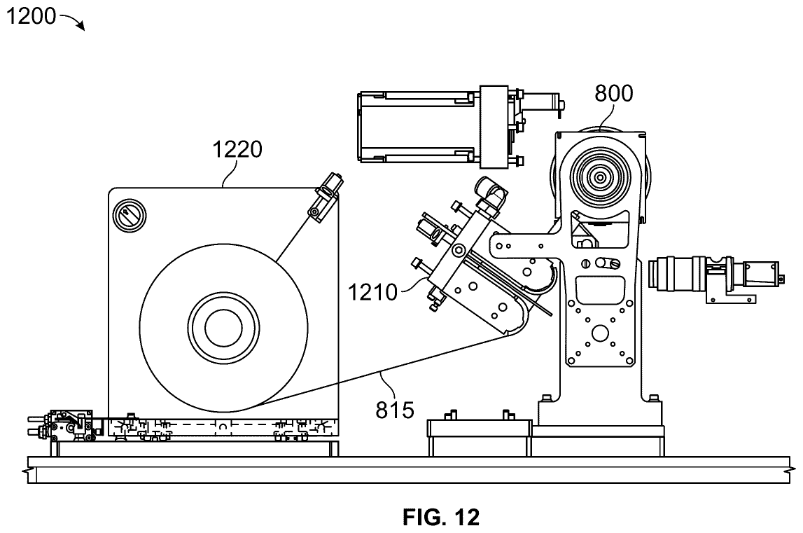

Looking now at FIG. 12, an exemplary system 1200 in which a singulation device 800 according to the present disclosure may be used in is shown.

The singulation device 800 requires some type of device to feed the film material to it. Due to the index motion used by the singulation device to withdraw the film material, comprising a rapid acceleration followed by a rapid deceleration, and typically a complete stop, the film material must be fed in a way that is virtually frictionless, which in turn entails that the withdrawal of film material is virtually free from inertia. If this is not the case, the withdrawing of the film material with such an index motion would damage the film, or not be possible at all.

In some embodiments, the singulation device 800 may be fed by a buffering device 1210, which in turn is receiving film from a film dispensing device 420. The film dispensing device 1220 may be a dereeler assembly comprising a roll of film material wound around an air chuck.

Withdrawing the film material with an index motion as described herein would not be possible from such a film dispensing device. Thus, an intermediary device in the form of a buffering device 1210 may be required.

The buffering device 1210 is adapted to receive film material from the film dispensing device 1220 at a constant speed, and output the film material at a variable speed to the singulation device, wherein the variable speed may be the index motion with which the singulation device withdraws the film material from the buffering device 1210.

In some embodiments, the buffering device 1210 may comprise a first transportation portion, a buffering portion, and a second transportation portion, wherein the film material is adapted to travel with the constant speed through the first transportation portion and to travel with the variable speed through the second transportation portion. In some embodiments, both the first and second transportation portions comprise air bearings, such that the film material travels on the air in order to achieve a substantially frictionless and/or inertia free transfer of the film material.

In some embodiments, the system may further comprise a picking device (not shown). The picking device is adapted to pick sheet of film material from the singulation device 800 after it has been cut. In some embodiments, the picking device comprises an arced surface which comes into contact with a face of the singulation device as it picks up the cut film material.

In some embodiments, the picking device is adapted to pick up the film material using suction, and may thus comprise suction means for adhering the film material to the picking device. In some embodiments, the picking device is adapted to use its suction to also adhere an electrode to it, while also adhering the cut film material. In some embodiments, the picking device is adapted to transport the film material, and optionally also the electrode, from the singulation device to a battery stack, wherein the film material is separator material used in battery manufacturing.

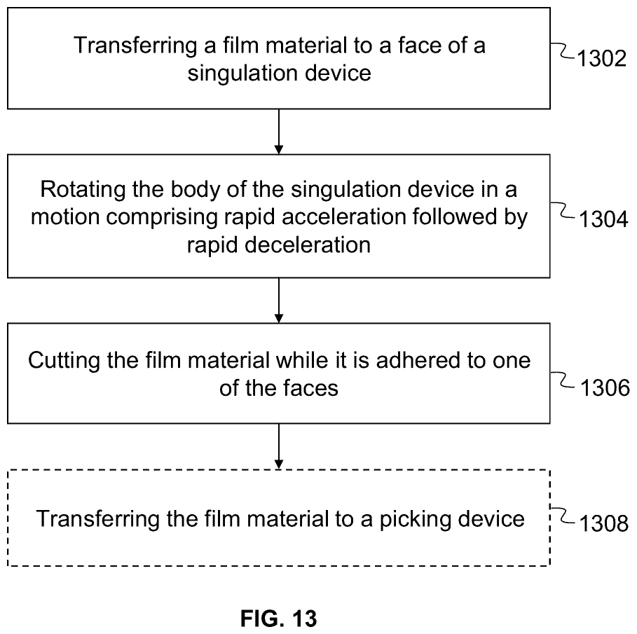

Looking now at FIG. 13, a method 1300 for cutting a film material into pieces according to an embodiment will now be described.

The method comprises transferring 1302 a film material to a face of a singulation device as described to embodiments herein, comprising a body with at least two substantially flat faces for receiving the film material, wherein each face is adapted to adhere the film material to the face, wherein the body is adapted to rotate around an axis.

The method further comprises rotating 1304 the body of the singulation device in an index motion comprising rapid acceleration followed by rapid deceleration. By rotating 1304, the film material is transferred from a first position to a second position on the singulation device. By rotating again, the film material may be transferred again from a second to a third position, from a third to a fourth, and so on, depending on how many faces the singulation device comprises. At least one of the positions is a cutting position in which the film material can be cut by the singulation device.

The method further comprises cutting 1306 the film material while it is adhered to a face of the singulation device.

The method may in some embodiments further comprise transferring 1308 the film material to a picking device. In some embodiments, the transferring 1308 comprises stopping the adhering of the film material to the face when it is picked by the picking device.

### Buffering Device

Briefly described, the present solution relates to a device, as well as a corresponding system and method, for receiving a film material, especially a separator material used in battery stacking, at a constant speed and outputting it at a variable speed. Even though it's especially suitable for use in battery manufacturing, the device can be used for any type of film material.

When assembling a battery stack, separator material is generally fed from a film dispensing device at a constant or substantially constant speed. However, in order to cut the separator material into discrete sheets, a length of separator material needs to be withdrawn in an index motion comprising a high acceleration followed by a rapid deceleration, which may include a complete stop, in order to cut the material with high precision. The inertia when trying to quickly withdraw separator from a device dispensing the roller is generally too high in order to make it viable to withdraw the film in such a manner directly from the dispensing device.

Thus, the present disclosure provides a buffering device that can be positioned between a film dispensing device dispensing a film material at a constant speed and a film withdrawing device adapted to withdraw the film material at a variable speed, especially in an index motion comprising an acceleration followed by a deceleration, and which may comprise a complete stop following the deceleration. The buffering device provides a way to withdraw film material with from a source with inertia, and outputting it with no or virtually no inertia in order to enable withdrawal at very high speeds and/or with very high acceleration. Preferably, the acceleration and deceleration occur rapidly, in order to enable high speed operations of the buffering device and the system in which it operates.

The device comprises a first transportation portion in which the film material is adapted to travel at a constant or substantially constant speed, a buffering portion adapted to accommodate the film material, and a second transportation portion in which the film material is adapted to travel at a variable speed, wherein the variable speed has a minimum speed which is lower than the constant speed and a maximum speed which is higher than the maximum speed, but wherein the average speed of the variable speed over time is the same or substantially the same as the constant speed. That the film material is adapted to travel at a certain speed is also referred to as that the buffering device is adapted to transport the film material at that speed, although no active transportation steps may be performed by the buffering device.

For the purpose of this disclosure, an index motion is a motion intended to position something in a specific position with high precision. The most common index motion referenced in this disclosure is one comprising a rapid acceleration followed by a rapid deceleration, which may include a complete stop.

For the purpose of this disclosure, a film material is a thin and at least somewhat flexible material, wherein the material may be e.g. nonwoven fibers, polymer films, and naturally occurring substances such as rubber and asbestos. The film material may be in the form of a sheet, a web or a mat and may comprise directionally or randomly oriented fibers. The film material may comprise single or multiple layers of material.

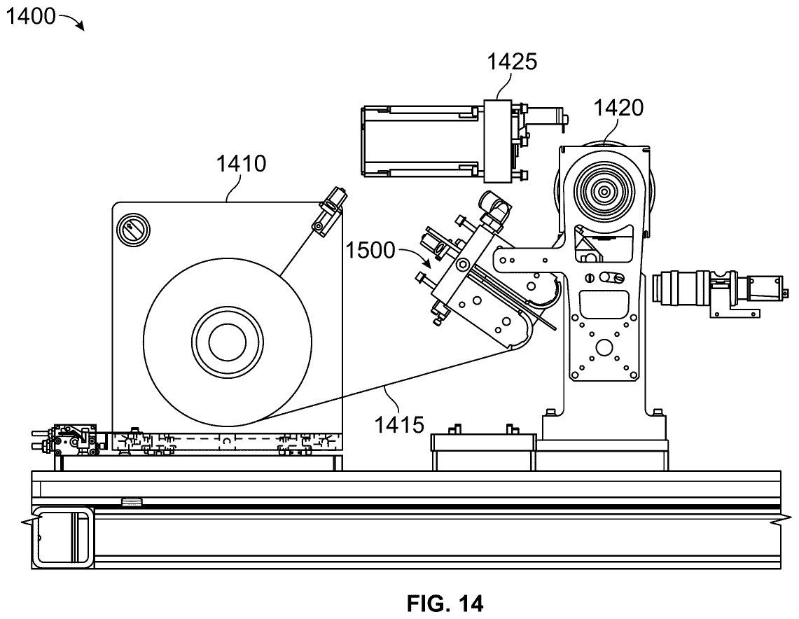

Looking now at FIG. 14, an exemplary system in which the buffering device according to the present disclosure is relevant will now be described, together with a description of how it may be used.

The system 1400 comprises a film dispensing device 1410 which outputs a film material 1415 at a constant or substantially constant speed. The dispensing device 1410 may for example comprise a roll of film material positioned on an air chuck and a servo motor for controlling the output speed.

The system 1400 further comprises a buffering device 1500, adapted to receive the film material being dispensed from the film dispensing device 1410 at a constant speed, and output the film material at a variable speed. The variable speed is, on average, the same as the constant speed, but comprises both lower and higher speeds during one iteration of a withdrawal operation.

The system further comprises a film withdrawing device 1420 adapted to withdraw the film material at a variable speed. In some embodiments, withdrawing the film material comprises repeating instances of index motions, each index motion comprising a rapid acceleration followed by a rapid deceleration, which may include a complete stop, with a minimum speed lower than the constant speed and a maximum speed higher than the constant speed.

For example, the film withdrawing device 1420 of FIG. 14 comprises four flat faces which can rotate around an axis. One index motion withdraws film from the buffering device 1500 approximately equal to one face of the film withdrawing device. After withdrawing film from the buffering device 1500, the film withdrawing device stops or continues feeding at a very low speed, and the film is cut into a discrete sheet from the continuous roll by use of a cutter assembly 1425. In some embodiments, the cutter assembly 1425 is a part of the film withdrawing device, and in some embodiments it's a separate device.

The system shown in FIG. 14 may be a system used for battery manufacturing. The film material 1415 may in some embodiments be a separator material intended to be put between alternating layers or anodes and cathodes in a battery stack. However, the present disclosure is not limited to being used on separator material, it may be used for any other film material that is withdrawn with a variable speed while being fed at a constant rate from a film dispensing device.

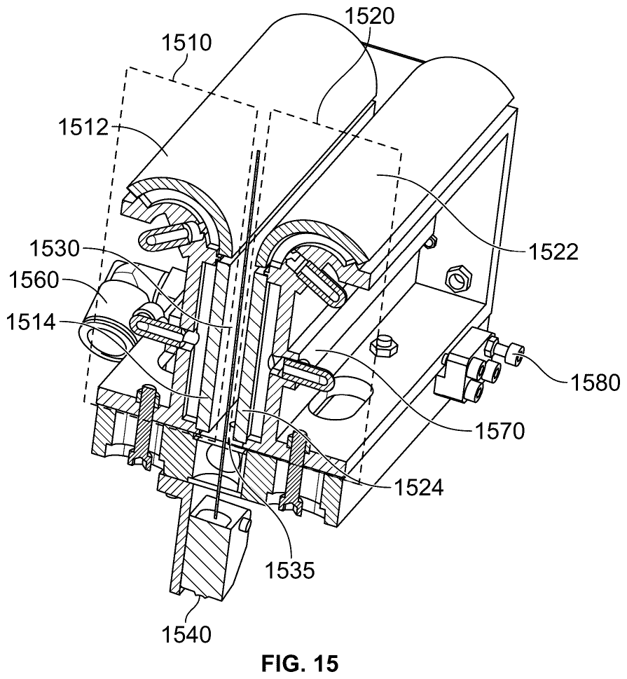

Looking now at FIG. 15, one embodiment of a buffering device 1500 according to the present disclosure will now be described.

The buffering device 1500 comprises a first transportation portion 1510, a second transportation portion 1520, and a buffering portion 1530 in between the first and second transportation portions. The first transportation portion may in some embodiments comprise a curved portion 1512 leading into a flat portion 1514. The second transportation portion may in some embodiments comprise a curved portion 1522 and a flat portion 1524.

In some embodiments the first and second transportation portions are identical in structure, but mirrored in their positions. In some embodiments, the size of the first and transportation portions may differ. The portions may differ with respect to both dimensions and shape. In embodiments comprising a curved portion and a flat portion, the size of one, or both of these portions may differ between the first and second transportation portion. The main reason for having different size, shapes and angles of the first and second transportation portion is due to the system in which they operate, including the positions and angles of the preceding and following devices, such as the film dispensing device and the film withdrawing device.

The first transportation portion 1510 is adapted to transport the film material at the constant speed, and the second transportation portion 1520 is adapted to transport the film material at the variable speed. Another way of putting is that the buffering device 1500 is adapted to have the film material travel through the transportation portions at different speeds. It is not necessary for either of the transportation portions to comprise any means for actually transporting the film material by itself.

In some embodiments, both the first and second transportation portions comprises an air bearing, and the buffering portion 1530 comprises suctioning means which pull the film towards the bottom 1535 of the buffering portion 1530. Such suctioning means in combination with the film dispensing device 1410 dispensing the film at the constant speed keeps the film material under tension and keeps it flowing towards the bottom 1535 of the buffering portion 1530, while traveling across the air bearing of the first transportation portion.

Due to the suction provided by the suctioning means, the amount of film material on each side in the buffering portion will be approximately the same. When film is withdrawn from the buffering portion 1530, this entails that the amount of film material on the flat portions of the transportation portion will decrease with approximately half of the amount of film material withdrawn.

By having an air bearing as the surface on which the film material is transported through the first and/or second transportation portions, the buffering device may comprise no or very few moving parts. Having no or few moving parts may be beneficial for having a robust system which is not as affected by wear and tear.

Then, the film withdrawing device 1420 pulls the film material which is being provided in the buffering portion, and withdraws an amount of film that is to be cut into a discrete sheet. Typically, the film withdrawing device 1420 pulls the film when there is enough film material in the buffering portion to be pulled without the film material ever being pulled above a predetermined level 1550. If the film material is pulled above the predetermined level 1550, it may cause disturbances in the system.

In some embodiments, the time between withdrawal operations may be between 0.1-2 seconds, which entails that the time for one index motion is less than or the same as that. In some embodiments, the time is approximately 1 second. In some embodiments, it's approximately 0.5 seconds. In some embodiments, it's approximately 0.2 seconds. This entails that the time for withdrawing the length of one sheet of film material is the same or smaller.

In some embodiments, the buffering portion of the buffering device is adapted to accommodate 1.5-3 times as much film material as is being withdrawn by the film withdrawing device in one withdrawing operation.

In some embodiments, the buffering device 1500 further comprises a measuring device 1540, for example a laser. The measuring device 1540 is adapted to measure a position of the film material in the buffering portion 1530 as it is pulled towards the bottom 1535 of the buffering portion 1530 by the suction means, and/or as it is pulled by the film withdrawing device. By determining the position of the film material at the buffering portion, a feedback loop can be created and in case there is a discrepancy between the constant speed at which the film material is output from the film dispensing device 1410, and the average speed of the variable speed with which the film withdrawing device is withdrawing the film, either of these speeds can be adjusted. If there is a discrepancy between them, it would be indicated by that the position of the film at the start of a withdrawing operation differs between subsequent withdrawing operations. In some embodiments, the speed of the film withdrawing device is always the same and only the speed of the film dispensing device is adjusted in case of a discrepancy.

As will be understood, if the constant speed by which the film is dispensed by the film dispensing device 1410 is changed due to such a discrepancy, it is not entirely constant with respect to before and after such an adjustment. However, the speed is always constant during a specific withdrawing operation, and it is generally substantially constant over time as well. In some embodiments, in case there is an adjustment of the feeding speed of the film withdrawing device, it is in the range of 0-2%, preferably below 1%, and more preferably only a few tenths of a percent.

The suction means on the bottom 1535 of the buffering device 1500 may be provided by means of a vacuum source. The vacuum source can be positioned externally to the buffering device itself, as long as it is physically connected to the buffering device 1500. In some embodiments, the buffering device 1500 may thus comprise a vacuum port 1560 adapted to provide vacuum in order to achieve a suction at and towards the bottom 1535 of the buffering device 1500.

Further, the buffering device 1500 may comprise an air supply 1570 for providing air for the air bearings, in embodiments wherein one or both transportation portions 1510, 1520 comprise air bearings. The first and second transportation portions 1510, 1520 may further comprise cavities for supplying pressurized air to both the rounded and flat portions.

A purpose of the transportation portions 1510, 1520 is to enable a transfer of the film material to the film withdrawing device with low friction and inertia, preferably without friction or inertia altogether, or at least with substantially no inertia or friction.

In some embodiments wherein the transportation portions comprise air bearings, the air bearings are made from a porous material such that air can be provided through the pores in the material, creating the air bearing on which the film is transported.

In some embodiments, the buffering device 1500 further comprises adjustment means 1580 for adjusting the angle and/or position of the first and/or second transportation portion. In some embodiments, the first transportation portion 1510 has one adjustment means 1580 associated with it and the second transportation portion has another adjustment means 1580 associated with it. In some embodiments, the same adjustment means 1580 is used for adjusting both transportation portions, such that they can be adjusted individually or at the same time. In embodiments where one or both transportation portions comprise both a flat portion and a curved portion, such as the one shown in FIG. 15, the adjustment means 1580 may be used to adjust the flat portions either in combination or independently from the curved portions.

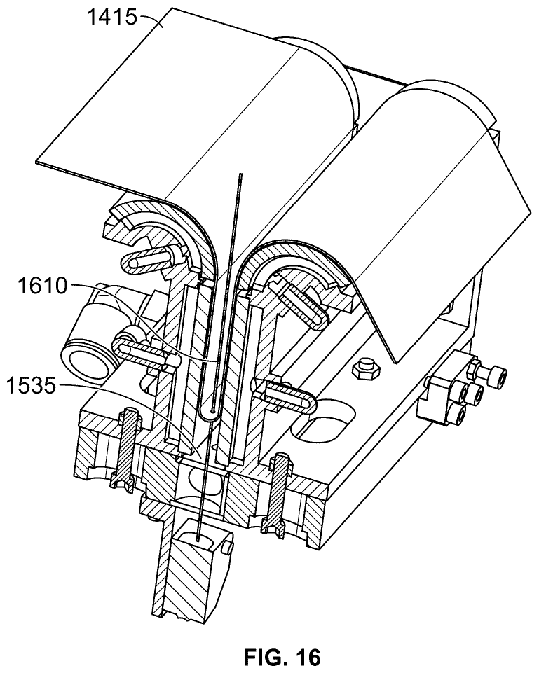

Looking now at FIG. 16, a view is shown where the film material 1415 is being transported through the buffering device 1500. As described previously, the film material 1415 is pulled towards the bottom 1535 of the buffering portion 1530 of the buffering device, and the measurement device is measuring the position of the film material. In embodiments where the suction means comprise vacuum, there will be a vacuum present below the level 1610 of the film shown in FIG. 16. As will be understood, since the position of the film material 1415 changes as the system is operating, the region below which there is a vacuum will continuously change during operation, but it will follow the same or approximately the same pattern for each withdrawing operation.

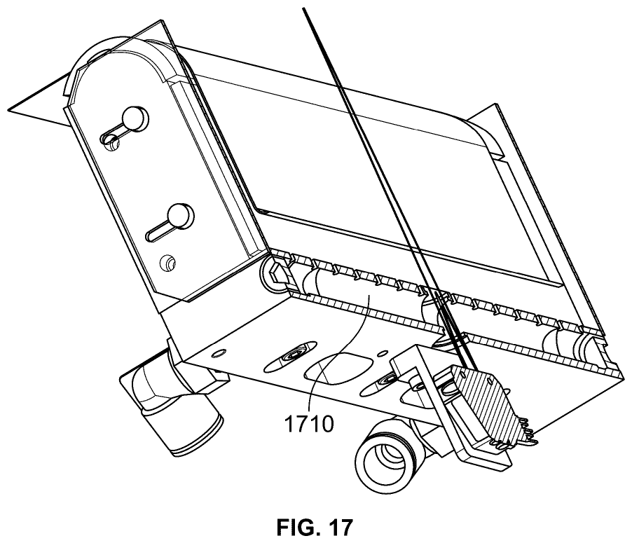

Looking now at FIG. 17, half of the buffering device 1500 according to an embodiment is shown, comprising the first transportation portion 1510. As will be understood, in embodiments wherein the transportation portions are identical in structure, what is shown in FIG. 17 may also be the second transportation portion 1520. At the bottom 1535 of the buffering device 1500, there may in some embodiments be a vacuum channel 1710, adapted to provide the suction at the bottom 1535 of the buffering portion 1530 of the buffering device. The vacuum channel 1710 may comprise a plurality of holes, in order to provide an equal distribution of the suction across the entire buffering portion 1530 of the buffering device.

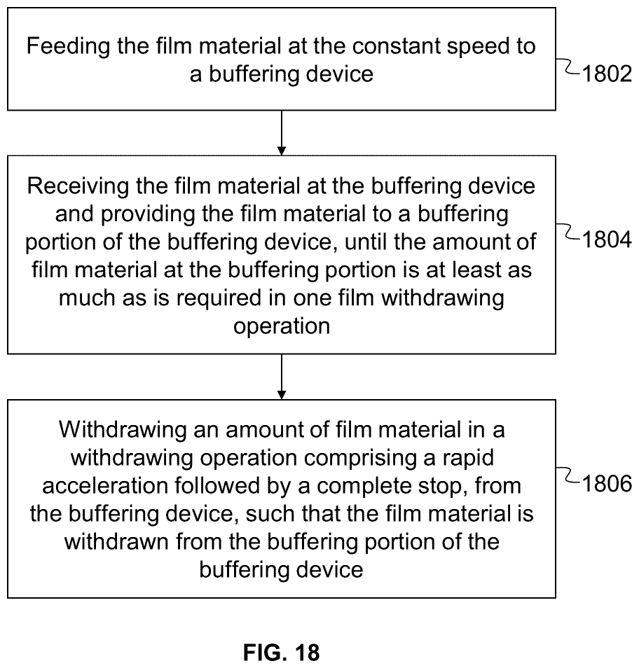

Looking now at FIG. 18, steps of a method for transferring a film material according to an embodiment will now be described. The method may in some embodiments be performed by a buffering device as described herein, and/or in a system as described herein.

The method comprises transferring a film material from a film dispensing device dispensing the film material at a constant speed to a film withdrawing device withdrawing the film material with a repeating instances of motion comprising a rapid acceleration followed by a rapid deceleration, which may include a complete stop.

The method comprises feeding 1802 the film material at the constant speed to a buffering device. The buffering device may be a buffering device as described herein.

The method further comprises receiving 1804 the film material at the buffering device and providing the film material to a buffering portion of the buffering device, until the amount of film material at the buffering portion is at least as much as is required in one film withdrawing operation.

In some embodiments, the buffering portion of the buffering device is adapted to keep the film material under tension. By keeping the film material under tension even while it is in the buffering portion, it is ensured that the film material is in a position suitable for the subsequent withdrawing of the film material. In some embodiments, this entails that the film material is kept under tension by suction, which may include a vacuum source.

In some embodiments, a majority of the film material is positioned on a surface while being in the buffering portion. By having the film material positioned on a surface of the buffering portion, it is further ensured that the film material is in a position suitable for the subsequent withdrawing of the film material.

The method further comprises withdrawing 1806 an amount of film material from the buffering portion of the buffering device, in a withdrawing operation comprising acceleration followed by a deceleration. In some embodiments, the withdrawing operation further comprises a complete stop after the deceleration.

In some embodiments, the withdrawing 1806 comprises withdrawing an amount of film material which is to be cut into a single piece. In some embodiments, the withdrawing 1806 further comprises cutting the film material. In some embodiments, the withdrawing 1806 comprises withdrawing film with an index motion, comprising rapid acceleration followed by rapid deceleration, which may include a complete stop following the deceleration.

The previous examples have been provided merely for explanation and are in no way to be construed as limiting the present invention disclosed herein. While the invention has been described regarding various embodiments, it is understood that the words used herein are words of description and illustration rather than words of limitation. Further, although the invention has been described herein concerning particular means, materials, and embodiments, the invention is not intended to be limited to the particulars disclosed herein; instead, the invention extends to all functionally equivalent structures, methods, and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other construction details are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

1. A system for stacking singulated electrodes in a battery stack, comprising:
a first singulation device having at least three faces, a cutting device, and a first buffering device, wherein the first singulation device is configured to singulate electrodes from a film material;
a second singulation device having at least three faces, a cutting device, and a second buffering device, wherein the first singulation device is configured to singulate electrodes from a film material;
a third singulation device having at least three faces, a cutting device, and a third buffering device, wherein the first singulation device is configured to singulate electrodes from a film material;
a first in-feed conveyor, wherein the first in-feed conveyor is configured to transport the singulated electrodes from the first singulation device to a first nest;
a second in-feed conveyor, wherein the second in-feed conveyor is configured to transport singulated electrodes from the second singulation device to a second nest;
a third in-feed conveyor, wherein the third in-feed conveyor is configured to transport singulated separator sheets from the third singulation device to a third nest;
a transportation device having at least one vacuum-assisted gripping shoe, wherein the transportation device is configured to transfer an anode, a cathode, and a separator from the first, second, and third nests of each of the respective first in-feed conveyor, second in-feed conveyor, and third in-feed conveyor to a picking device using the at least one vacuum-assisted gripping shoe;
wherein the picking device is further configured to pick the anode, the cathode, and the separator from the at least one vacuum-assisted gripping shoe of the transportation device using one of at least three gripping shoes coupled to the picking device;
at least one battery stacking station adapted to receive at least one singulated anode, at least one singulated cathode, and at least one singulated separator material;
wherein the at least one battery stacking station is adapted to be positioned at a battery stacking position and a battery removal position; and
a removal device, adapted to remove a battery stack from the at least one battery stacking station when it is in a battery removal position.

2. The system according to claim 1, wherein the transportation device is adapted to alternately transfer an anode and a cathode to the rotating picking device.

3. The system according to claim 1, wherein the transportation device has one position in which it is simultaneously gripping an anode and releasing a cathode and one position in which it is simultaneously gripping a cathode and releasing an anode.

4. The system according to claim 1, further comprises quality inspection devices adapted to inspect the cathodes, the separators, and the anodes before they are transferred to the first, second, and third nests.

5. The system according to claim 1, further comprises quality inspection devices adapted to inspect the cathodes, the separators, and the anodes before they are transferred to the picking device.

6. The system according to claim 1, wherein each of the first, second, and third nests further comprises an alignment device configured to align the electrodes and separators.

7. The system according to claim 1, wherein the transportation device comprises an alignment device configured to align the electrodes and separators.

8. The system according to claim 1, wherein each of the first, second, and third nests further comprises air bearings on which the electrodes are positioned.

9. The system according to claim 1, further comprising a second battery stacking station.

10. The system according to claim 9, wherein the first battery stacking station and second battery stacking station further comprise:
a vacuum source that is fluidly coupled to the first battery stacking station and the second battery stacking station, wherein the vacuum source is adapted to exert a suction force on the battery stack that encircles the battery stack.

11. (canceled)

12. The system according to claim 10, wherein each battery stacking station is positioned on a mechanical transportation device, and is thereby adapted to move along at least two axes that are perpendicular to each other.

13. The system according to claim 10, wherein each battery stacking station comprises a movable side wall.

14. The system according to claim 1, wherein the first, second, and third buffering devices are adapted to output a predetermined length of the film material in an index motion, the index motion comprising a rapid acceleration followed by a rapid deceleration.

15. The system according to claim 1, wherein the first, second, and third buffer devices further comprises a suction plate comprising a vacuum source adapted to pull the film material towards it.

16. The system according to claim 1, wherein the first, second, and third buffering devices further comprises a measuring device for determining a position of the film material.

17. The system according to claim 1, wherein the first, second, and third singulation device provides an index motion that includes a complete stop of the film material and cuts the film material during the stop.

18. The system according to claim 1, wherein the first, second, and third singulation device wherein the film material is adhered the at least three faces of the first, second, and third singulation devices using suction.

19. The system according to claim 1, wherein the first, second, and third singulation device is configured to apply different amounts of suction to each of the at least three faces.

20. The system according to claim 1, wherein the cutting device of the first, second, and third singulation devices is a blade.
